(19) United States
(12) Patent Application Publication
(10) Pub. No.: US 2010/0271288 A1
(43) Pub. Date: Oct. 28, 2010

(54) Automatic synchronized scaling of views during application sharing

(76) Inventors: Sudharshan Srinivasan, Fremont, CA (US); Kothandraman Ramchandran, Fremont, CA (US); Jai Kumar, Cupertino, CA (US)

Correspondence Address: SUDHARSHAN SRINIVASAN, 5496 GOLUBIN COMMON, FREMONT, CA, 94555, US

(21) Appl. No.: 12/386,872

(22) Filed: Apr. 24, 2009

(51) Int. Cl. G09G 5/00

(52) U.S. Cl. 345/2.2

(57) ABSTRACT

A method and device that support automatic scaling of display output of a shared application are described.

Display output of a shared application from a device with large display (33) is received at a device with small display (31) and scaled down to fit the boundaries of device with small display (31). This scaled down display output is then shown as overall content (44) in background layer (40) on device with small display (31).

Information about work area view (46) is also received at the device with small display (31) and is mapped to contents of the background layer (40). Then mapped contents are automatically scaled up to user defined levels and displayed in foreground layer (41). The contents of foreground layer (41) may be fixed or may be synchronized with changes in work area view (46) at device with large display (33).

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of Invention

The present invention generally relates to display sharing methods and specifically to display sharing methods using automatic synchronized scaling of views.

2. Prior Art US Patent

A display sharing system enables applications to share display output across multiple participants in a display sharing session. A display sharing session is a communication channel between multiple participant users and a set of one or more common applications whose display output and input are shared.

There are several prior art systems that enable display sharing. In particular there are systems provided by companies like vnc, webex and citrix.

Such display sharing systems are commonly used across desktop computers where multiple desktop computers share display output of one or more applications from any one of the desktop computers.

But one key requirement of such systems is that, displays of all devices participating in a display sharing session must be of same size. Otherwise users using devices with different display sizes will get different snapshots of the display output of the shared application. A subpart of the display output of the shared application shall further be referred to as a view.

As an example, if some of the devices are mobile devices that have very small displays, it is difficult for a large desktop display output to be fit into a smaller display without loss of clarity and resolution.

In order to solve this display size incompatibility problem, some prior art systems propose automatic synchronization of a viewport between displays of differing sizes. In such a system a viewport representing a bounding box around the current working area in a larger display, is aligned with the geometry of a smaller display device. Then as a user using the large display moves the viewport, the view in the smaller display device is automatically scrolled such that contents in the smaller display are in sync with the contents of the viewport in the larger display.

Although this is a valid solution to the problem of managing display sharing across devices with different display sizes, it suffers from one major limitation. The limitation is that when a view in the smaller display device is scrolled automatically, the viewer using the smaller display device will lose context of the original content being displayed as the original content is scrolled out of visible region. In particular, if the smaller display device is a mobile device with screen size less than one fourth the screen size of a large display at a desktop computer, the context difference is more apparent and hence renders this solution unusable.

Hence it can be seen that there is a need for application display sharing system that enables viewing selective portions of display content without losing the context of the entire display output.

Currently there are no known prior art methods that offer a solution to this problem.

Following paragraphs in current section describe relevant prior arts in this field.

Prior art U.S. Pat. No. 5,867,156 proposes a method of automatic viewport synchronization across displays of differing sizes. This solution suffers from the limitations mentioned above. If a viewport in the larger display moves beyond the total size of the smaller display, then all content being viewed in the smaller display will be overwritten with new content, hence all relevant context will be lost. Hence this method does not address the need for enabling a user of a device with smaller display to see the contents of work area view of the larger display while keeping the full content in perspective for maintaining context.

Prior art U.S. Pat. No. 7,376,695 proposes a method for generating a graphical display for a remote terminal session. This method suggests capturing of graphical drawing primitives from application display output instead of capturing images. Capturing graphical drawing primitives helps in reducing network bandwidth usage and enables scaling graphical output to different display sizes without loss of resolution. But if this method is used with a display that is much smaller than a desktop computer display, then all the output will be scaled down to this smaller size and render the display output unreadable. Hence this method does not address the need for enabling a user of a device with smaller display to see the contents of work area view of the larger display while keeping the full content in perspective for maintaining context.

Prior art U.S. Pat. No. 6,654,032 proposes a method of sharing display output with multiple users where a certain area of interest from display output of a user who is the content originator, is shared with other users who are content consumers. This area of interest that is to be shared is represented by a transparent window on the content originators display. This prior art only addresses how a common area of interest is rendered in each of the user displays but does not address the problem of sharing display output across displays of varying sizes and resolutions. Hence this method does not address the need for enabling a user of a device with smaller display to see the contents of work area view of the larger display while keeping the full content in perspective for maintaining context.

Prior art U.S. Pat. No. 7,287,220 proposes a method to display graphical content that is authored for bigger displays in a smaller display. It proposes scaling down the resolution of fonts and image bitmaps to lower resolution and remap to fonts available in devices with lower resolution and display sizes. This addresses a problem where retaining original resolution on smaller displays is either not feasible or will render the fonts so small that they will be difficult to read. Hence scaling down the resolution improves the readability while retaining the original layout. But this prior art does not address the problem of sharing display output across displays of varying sizes and resolutions. Hence this method does not address the need for enabling a user of a device with smaller display to see the contents of work area view of the larger display while keeping the full content in perspective for maintaining context.

Prior art U.S. Pat. No. 7,219,309 proposes viewing web pages with multiple scale factors on the same screen. This Prior art only addresses the problem of a single user and one type of display related to the user. It enables a large web page to be viewed in parts where one part is a larger overview and the other part is a smaller portion but scaled to desired extent. But this does not address a problem that occurs when sharing display output of any shared application with users having different display sizes. The problem of sharing display output of larger displays with devices using smaller displays is that a person using a device with smaller display will lose context of where the original content is if the original content is scrolled out of view. This prior art only addresses a single user system where this problem need not be addressed and hence this prior art patent is not relevant.

Prior art US Doc 20050223343 proposes changing the shared area of a display based on a cursor position. This prior art does not address the problem of sharing display output across displays of varying sizes and resolutions. Hence this method does not address the need for enabling a user of a device with smaller display to see the contents of work area view of the larger display while keeping the full content in perspective for maintaining context.

As can be seen from above, all known prior arts suffer from some limitations in offering a solution that enables sharing application display output such that a user of a small display device is able to participate in a shared application session without losing context.

### OBJECTS AND ADVANTAGES

Accordingly, several objects and advantages of the present invention are:
a) to provide a display sharing method across devices of differing display sizes such that a user participating in a display sharing session who uses a device with a small display is able to maintain the full context along with ability to see the area being worked upon by a user using a device with a large display;
b) to provide a display sharing method across devices of differing display sizes such that network bandwidth is not wasted for displaying parts of the content that have been already viewed while keeping a user using a small display device in sync with a user using a large display device; and
c) to provide a display sharing method where multiple devices of differing display sizes can participate in a display sharing session without the need for the shared application to co-ordinate views across multiple devices. Each device is capable of providing a view to its user that most suits its display attributes while keeping overall content of display output from shared application in perspective.

### SUMMARY

In accordance with present invention a display sharing method is described where a device with smaller display is automatically synchronized with a device with larger display such that a user at the device with smaller display is able to distinguish the overall content of the shared display along with ability to view the work area representing a part of the larger display that is automatically scaled and synchronized to the work area view of a larger display.

This is achieved by rendering on the small display, a scaled down version of the complete display output of the large display as a background layer, along with a overlapping layer representing a smaller work area of the larger display such that content in the overlapping layer is scaled up to a user desired level. The overlapping layer is rendered as a transparent layer with configurable transparency such that a user using the device with smaller display is able to make this transparent layer completely opaque or completely transparent. Also, this transparent layer is automatically synchronized with the work area at a larger display. That is, if a user at the larger display moves the work area around using either pointer or keyboard input, the contents corresponding to the work area in the background layer are automatically scaled up and rendered into the transparent layer without having to get new content from the device with large display.

This automatic scaling of work area enables maintaining the overall context in a background layer while having a larger view of work area, thus enabling a user at a mobile device a much better screen sharing session as compared with prior art that are based on just viewport synchronization where new data may need to be received every time a desktop user moves around and the overall context is lost.

### DRAWINGS

### Figures

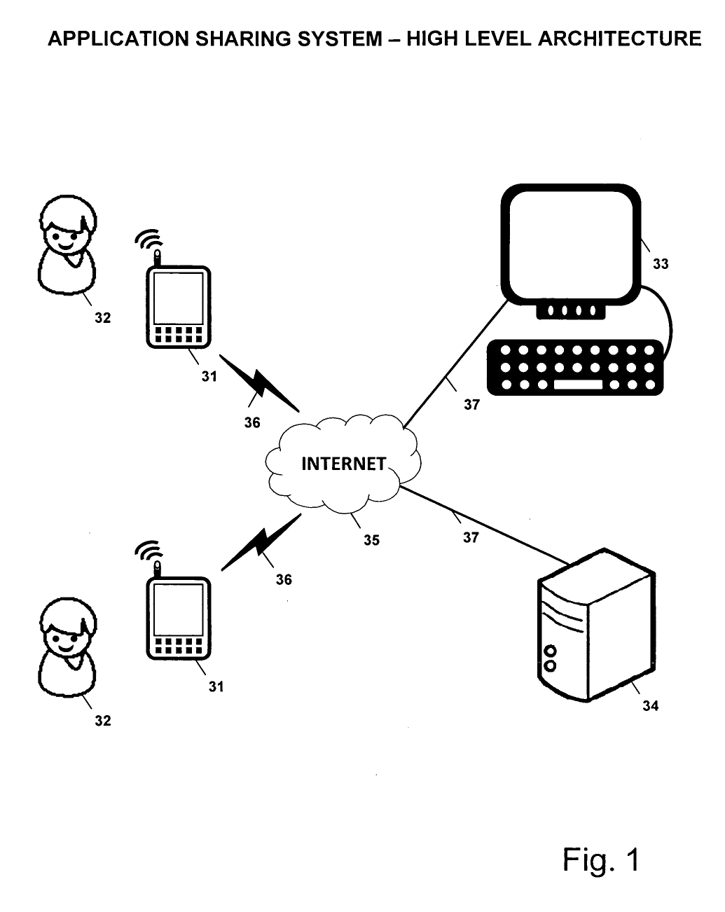

FIG. 1 shows the high level architecture of synchronized scaling of views during application sharing, the object of present invention.

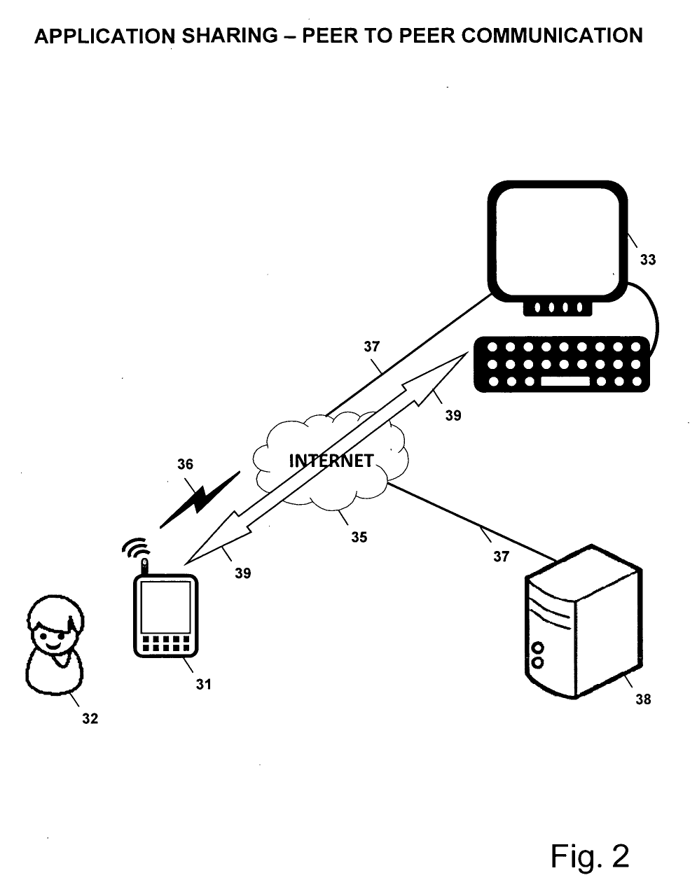

FIG. 2 shows the high level architecture of synchronized scaling of views during application sharing, using peer-to-peer networking.

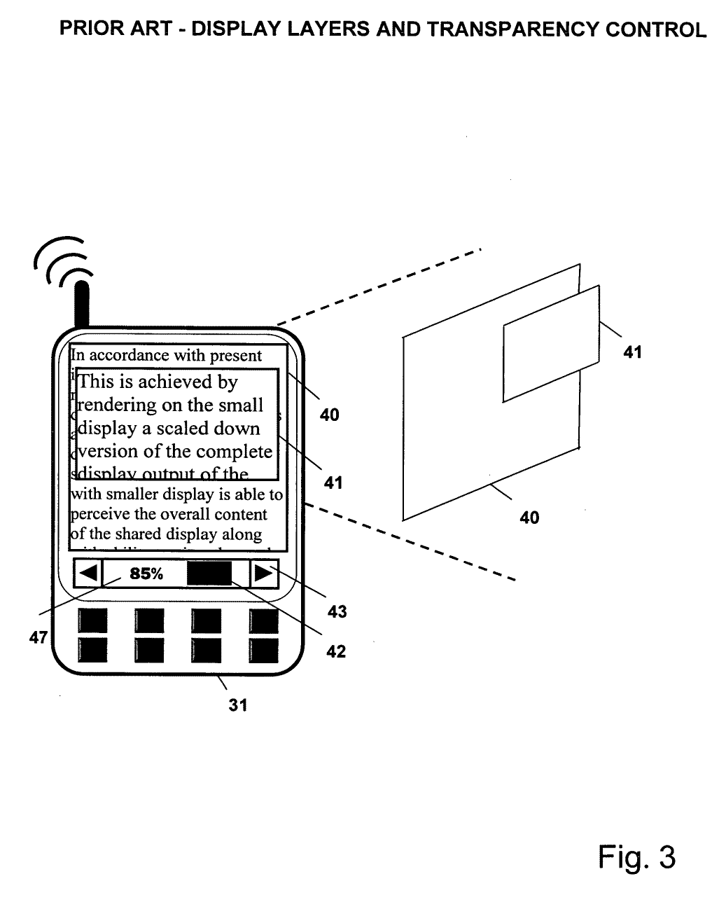

FIG. 3 shows prior art illustration of display layers in mobile device and transparency control feature to control display layer transparency.

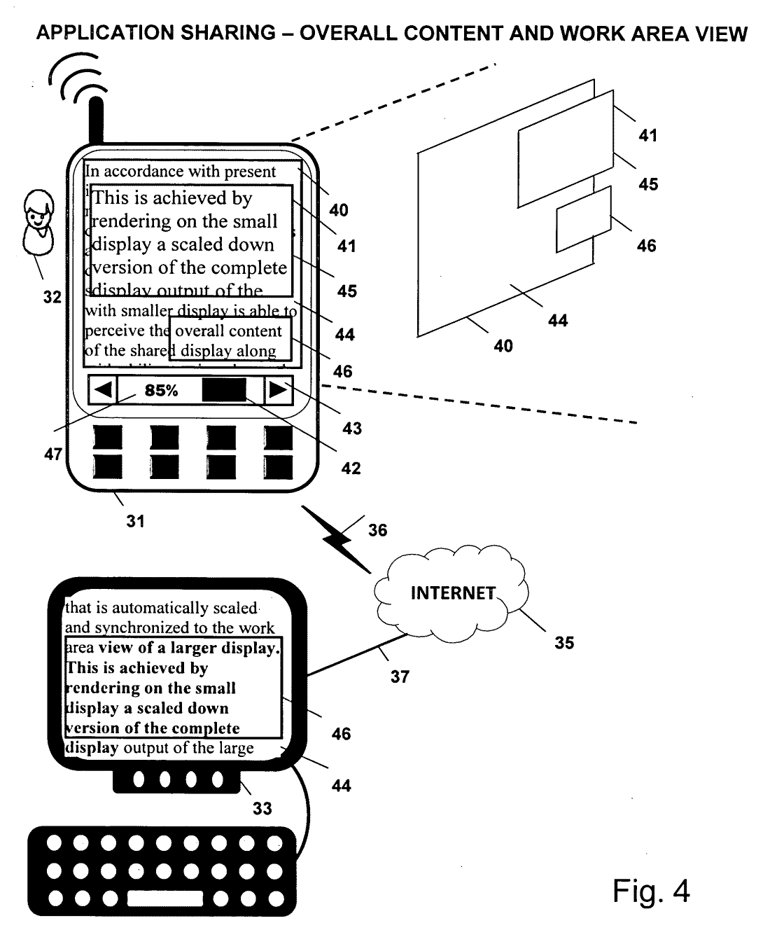

FIG. 4 shows a typical application sharing session involving overall content and scaled work area.

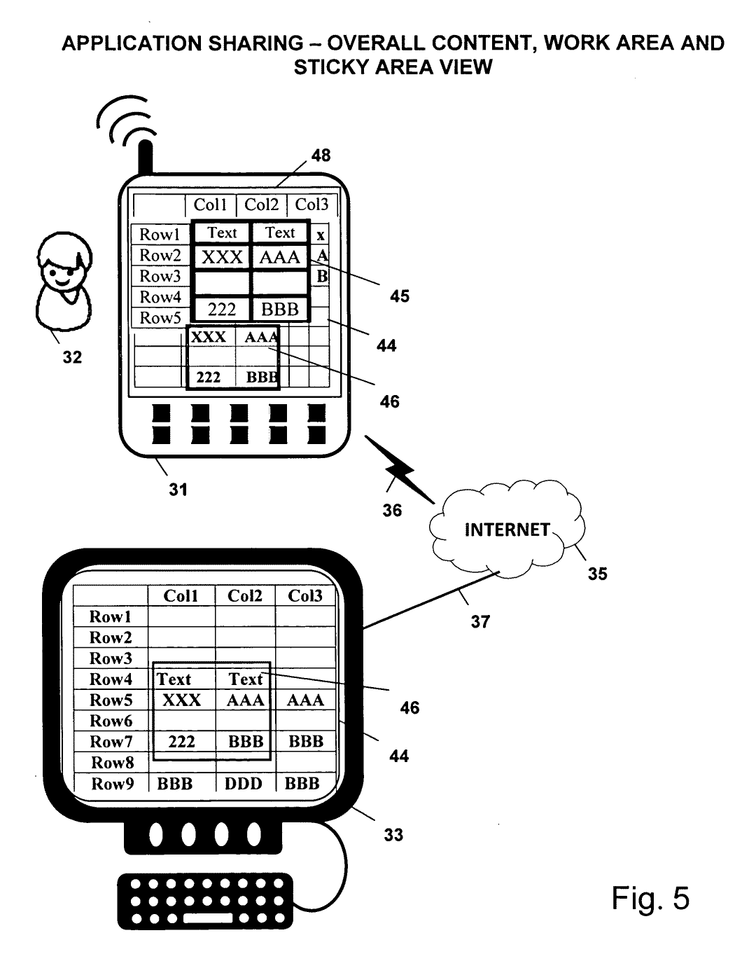

FIG. 5 shows a typical application sharing session involving overall content, scaled work area and also sticky area.

### DRAWINGS

### Reference Numerals

31 mobile devices
32 mobile application users
33 desktop
34 application sharing server
35 internet
36 wireless networks
37 internet connection
38 session management server
39 peer-to-peer networking
40 background layer
41 foreground layer
42 transparency control widget
43 transparency control scroller
44 overall content
45 scaled up work area view with configurable transparency
46 work area view
47 transparency control
48 sticky view area

### DETAILED DESCRIPTION OF PREFERRED EMBODIMENT

In the descriptions below first overall system architecture using server based application screen sharing and peer to peer application screen sharing is described, then details of synchronized automatic scaling without having to get new screen data into mobile device is described, that enables preserving context and seeing the work area at the same time.

FIG. 1 shows the high level architecture of synchronized scaling of views during application sharing using server based application screen sharing. One or more mobile devices 31 of mobile application users 32 and desktop 33 are connected to application sharing server 34 through internet 35. Mobile devices 31 are connected using wireless networks 36 and desktop 33 is connected using internet connection 37. Desktops 33 typically have larger displays with higher resolution, whereas mobile devices 31 have much smaller displays with lower resolution. This invention describes suitable application sharing scheme among mobile devices 31 and desktop 33 by automatically scaling the view to suit display of respective device. Additionally, overall context of application view is also provided to devices with smaller screens in order to significantly improve user experience.

FIG. 2 shows peer to peer based application screen sharing between mobile application user 32 of mobile device 31 and desktop 33. In this embodiment, session management server 38 hosts session management functionality only during application sharing session. Mobile device 31 and desktop 33 engage in peer-to-peer networking 39 for application sharing. In order to focus on more important aspects of this invention, the remainder of this section assumes only one mobile device 31 and desktop 33 engage in application session sharing using peer-to-peer networking.

FIG. 3 shows prior art illustration of display layers in mobile device and transparency control feature to control display layer transparency. Mobile devices are evolving rapidly in terms of processing power and quality of displays supported. These developments enable more and more desktop applications such as word processing, email and web browsing to be deployed on mobile devices. These applications require sophisticated window manager and display controller support. These applications also benefit greatly if window manager and display controllers support multiple display layers.

In this specific prior art illustration, mobile device 31 provides support for two display layers namely background layer 40 and foreground layer 41. This ability to display multiple layers allows applications to independently send data to be displayed in different layers. Mobile device 31 also shows transparency control widget 42 with support for transparency control scroller 43. Mobile device users 32 or applications running in mobile device 31 can adjust how background layer 40 and foreground layer 41 are displayed on the screen of mobile device 31. By sliding transparency control scroller 43, mobile devices users 32 or applications running in mobile device 31 can make background layer 40 data invisible, partially visible or fully visible after blending background layer 40 data with foreground layer 41. This invention makes use of multiple layer support available in prior art to implement application sharing session.

FIG. 4 shows a typical application sharing session between mobile application user 32 of mobile device 31 and desktop 33. Desktop 33 with large display shows overall content 44 of shared application. Mobile device 31 with smaller display is unable to present overall content 44 in a legible manner. But mobile user 32 is unable to enjoy complete application user experience without presentation of overall content 44.

According to this invention, this problem is addressed by presenting application content in multiple display layers simultaneously in mobile device 31 with support for display layers transparency control. Overall content 44 is presented as background layer 40 and simultaneously, scaled up work area view with configurable transparency 45 corresponding to work area view 46 is presented as foreground layer 41 in mobile device 31. Work area view 46 is scaled up such that display is easily readable in mobile device 31. Mobile application user 32 can make use of transparency control widget 42 to adjust how multiple display layers are presented. Setting transparency control 47 to highest level, will present overall content 44 and work area view 46 at same intensity level, whereas setting transparency control 47 to lowest level will hide overall content 44 and only display scaled up work area view 45 in mobile device 31.

Work area view 46 can be moved anywhere across overall content 44 either by mobile application user 32 using mobile device 31 or by desktop user using desktop 33. According to this invention, work area view 46 is automatically scaled up in mobile device 31 to generate scaled up work area view with configurable transparency 45.

Another important aspect of this invention is that both mobile and desktop users are simultaneously aware of work area view 46 location within overall content area 44. In mobile device 31, work area view 46 is highlighted with enclosed rectangle within overall content area 44. In desktop 33 with a large display, work area view 46 is also highlighted with enclosed rectangle within overall content area 44.

Multiple display layer support discussed in this invention can be implemented in either hardware or software. In one embodiment of this invention, hardware support available in display controller is used. For example, Marvel PXA27x line of processors with built-in display controllers support up to three display layers named as base display layer, overlay1 and overlay2 display layer. These display layers can be selectively enabled and also their display order can be controlled by programming display controllers.

In one embodiment on this invention, Marvel PXA27x LCD controller base layer is mapped to overall content area 44, whereas LCD controller overlay1 display layer is mapped to scaled up work area view 45. Transparency support provided by Marvel PXA27x LCD controller is used to implement transparency control 47.

In another embodiment of this invention, multiple display layer support may be implemented in software by window manager.

FIG. 5 shows application sharing session involving mobile application user 32 of mobile device 31 and desktop 33. Usability of applications such as spreadsheet and documents with tables are significantly improved if certain regions such as table row and column headers are continued to be displayed in specific display area even when work view area 46 is moved within overall content area 44. This is achieved in present invention by making use of sticky view area 48 that represents fixed areas in mobile device 31. Present invention enables mobile device 31 and desktop 33 to specify a certain display area in overlay layer normally available to work area view 46, to be assigned as sticky area view 48. Contents of sticky area view 48 do not change even when work area view 46 is moved and contents of sticky area view 48 are also scaled up to user desired level as done in scaled up work area view 45. It is also important to note that both sticky area view 48 and work area view 46 are highlighted as distinct rectangles within overall content area 44 in order to provide better overall context to mobile user 32 using mobile device 31.

### Advantages

From the description above a number of advantages of this display sharing method using two layers with automatic scaling and synchronization of work area view become evident:
a) a method for display sharing across devices of differing display sizes is provided such that a user participating in a display sharing session who uses a device with a small display is able to maintain the full context along with ability to see the area being worked upon by a user using a device with a large display;
b) a method for display sharing across devices of differing display sizes is provided where network bandwidth is not wasted for displaying parts of the content that have been already viewed while keeping a user using a small display device in sync with a user using a large display device; and
c) a method for display sharing across devices of differing display sizes is provided where users can participate in a display sharing session such that each device can make independent decisions of the content to be shown around the current work area of a shared application.

### CONCLUSION, RAMIFICATIONS AND SCOPE

Accordingly, the reader will see that automatic scaling of contents of work area displayed in a transparent layer with configurable transparency in a device with smaller display, along with all of the content from a device with larger display, displayed in a background layer behind the transparent layer, enables a user of device with smaller display to keep the overall context in perspective while focusing on edits to work area of interest without the need to scroll the contents beyond the visible region. Even though the contents of large display are scaled down and may become less readable, the overall context including the layout and positioning of content is still perceptible to a user.

Although the description above contains many specificities, these should not be construed as limiting the scope of invention but merely as providing illustrations of some of the presently preferred embodiments of this invention. Thus the scope of this invention should be determined by appended claims and their legal equivalents, rather than by example given.

We claim:

1. A method to share display output of a shared application on a device with a large display such as a display in a desktop computer, with plurality of devices with display sizes smaller than said large display, comprising:
a) transferring contents of complete display output of said device with large display to said device with small display;
b) scaling down said complete display output content to boundaries of display size of said device with small display to create a small display scaled down version of full content that fits into said device with small display;
c) rendering said scaled down version of full content into memory representing a background layer of display of said device with small display further referred to as background content layer;
d) marking areas at said display of said device with large display as work areas of interest;
e) transferring information about said work areas of interest to said device with small display;
f) receiving said information at said device with small display and mapping said information about said work areas of interest to work areas of interest at said background content layer further referred to as areas of interest at background content layer; and
g) scaling up automatically to user desired level the contents of said work areas of interest at said background layer and rendering said scaled up contents into memory of said device with small display representing another layer called foreground layer with configurable transparency.

2. The method to share display output of a shared application of claim 1, wherein said device with large display is selected from group consisting of a desktop computer, a laptop computer, and a server computer.

3. The method to share display output of a shared application of claim 1, wherein said device with small display is selected from group consisting of a personal digital assistant, a mobile phone, a smartphone, and a mobile internet device.

4. The method to share display output of a shared application of claim 1, wherein said contents of complete display output is selected from group consisting of display output that is resolution independent, and display output that is resolution dependent.

5. The method to share display output of a shared application of claim 1, wherein said marking of areas of interest is implemented using methods selected from group consisting of choosing one region of pixels, and choosing multiple regions of pixels from said device with large display.

6. The method to share display output of a shared application of claim 5, wherein said choosing regions of pixels is selected from group consisting of choosing based on cursor position, choosing based on keyboard input, and choosing based on fixed set of pixels based on current context of communication.

7. The method to share display output of a shared application of claim 1, further comprising:
a) tracking changes in said work areas of interest at said device with large display;
b) transferring information about said changes to said plurality of devices with small display;
c) receiving said information at about said changes device with small display and mapping said information about said changes to areas in said background layer; and
d) scaling up automatically to user desired level the contents of said work areas of interest at said background layer and rendering said scaled up contents into memory of said device with small display representing another layer called foreground layer with configurable transparency.

8. The method to share display output of a shared application of claim 1, further comprising:
a) receiving user input at said foreground layer of said device with small display;
b) transferring said user input from said device with small display to said shared application; and
c) transferring result of said user input from said shared application to said devices with small display and large display.

9. The method to share display output of a shared application of claim 1, further comprising:
a) partitioning said work areas of interest into a set of fixed and a set of dynamic areas on said device with small display at said foreground layer, wherein, contents of said fixed areas of interest are not updated automatically and contents of said dynamic areas are updated automatically corresponding to said work areas in said device with large display.

10. The method to share display output of a shared application of claim 1, further comprising:
a) reducing display output size of said shared application to match display size and resolution of said device with small display to enable fitting all content output of said shared application into display of said device with small display so that any scaling down can be avoided.

11. A device with small display whose display size is smaller than display of a desktop computer further referred to as device with large display, comprising:
a) display hardware and software enabling display of multiple layers of display output representing contents of display output of a shared application at a said device with large display;
b) software module enabling reception of information about contents of display output of said shared application at said device with large display;
c) software module enabling reception of information about work areas interest of said shared application at said device with large display;
d) scaling module to scale display content output selected from group consisting of hardware module, and software module; and
e) software module enabling automatic scaling of said work areas of interest and displaying said scaled contents in one of said desired layers of display of said device with small display.

12. The device with small display of claim 11, wherein said device with small display is selected from group consisting of a personal digital assistant, a mobile phone, a smartphone, and a mobile internet device.
